(19) United States
(12) Patent Application Publication
(10) Pub. No.: US 2015/0312472 A1
(43) Pub. Date: Oct. 29, 2015

(54) USER FRIENDLY INTERFACES AND CONTROLS FOR TARGETING SYSTEMS

(71) Applicant: BAE SYSTEMS INFORMATION AND ELECTRONIC SYSTEMS INTEGRATION INC., Nashua, NH (US)

(72) Inventors: David A. Richards, Merrimack, NH (US); Robert W. Costantino, Milford, NH (US); David S. Hunt, Londonderry, NH (US)

(21) Appl. No.: 14/649,579

(22) PCT Filed: Sep. 24, 2014
(86) PCT No.: PCT/US14/57079

§ 371 Date: Jun. 4, 2015

Related U.S. Application Data
(60) Provisional application No. 61/961,067, filed on Oct. 3, 2013.

(51) Int. Cl. H04N 5/232; G06F 3/0484

(52) U.S. Cl. CPC H04N 5/23216; G06F 3/04842; G06F 3/04847

(57) ABSTRACT

User friendly interfaces and controls for a targeting system are disclosed. In one example embodiment, the targeting system includes user friendly interfaces and controls for accessing the user friendly interfaces from a single hand position to facilitate targeting system user's eyes to focus on a target during an operation.

### CROSS-REFERENCE TO RELATED APPLICATIONS

This application claims rights under 35 USC §119(e) from U.S. Application 61/961,067 filed Oct. 3, 2013, the contents of which are incorporated herein by reference.

### BACKGROUND OF THE INVENTION

1. Field of the Invention

The present invention relates to targeting systems and more particularly to user friendly interfaces and controls for targeting systems.

2. Brief Description of Related Art

Targeting systems often have dissimilar and non-intuitive user interfaces and control schemes. Due to the complex nature of the targeting systems, these primitive interfaces increase a user's workload considerably and may result in a negative impact on training and usage. Confusing multiple button presses, may further result in difficult to implement and remember commands and control inputs. Furthermore, confusing and layered states and modes may contribute to difficulty in using the targeting systems and may place the user more at risk.

### SUMMARY OF THE INVENTION

User friendly interfaces and controls for a targeting system are disclosed. According to one aspect of the present subject matter, the targeting system includes a smart phone and/or a mobile device like user friendly interfaces and controls for accessing the user friendly interfaces from a single hand position to facilitate targeting system user's eyes to focus on a target during an operation.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a perspective view of a day/night camera including user friendly controls, according to an example embodiment of the present subject matter.

FIG. 2 is a perspective view of a rear side of the day/night camera, such as the one shown in FIG. 1, according to an example embodiment of the present subject matter.

FIG. 3 is a feature overview showing an example user friendly interface seen in a view finder of the day/night camera, shown in FIGS. 1 and 2, according to an example embodiment of the present subject matter.

FIG. 4 is an example user friendly interface displaying layers of data and its position on the user friendly interface, according to an example embodiment of the present subject matter.

FIG. 5 is an example user friendly interface displaying functions when the day/night camera, shown in FIGS. 1 and 2, is operating in a night mode, according to an example embodiment of the present subject matter.

FIG. 6 is an example user friendly interface displaying functions when the day/night camera, shown in FIGS. 1 and 2, is operating in a day mode, according to an example embodiment of the present subject matter.

### DETAILED DESCRIPTION OF THE INVENTION

The exemplary embodiments described herein in detail for illustrative purposes are subject to many variations in structure and design. The present technique utilizes control schemes that have become known with the advent of smart phones and mobile devices to streamline and optimize a targeting system user's experience. The present technique uses user friendly interfaces and controls, such as rotary control/select dynamic (mode specific) multi-function buttons to make the targeting system user experience faster o acquire and prosecute targets.

The terms “user” and “targeting system user” are being used interchangeably throughout the document.

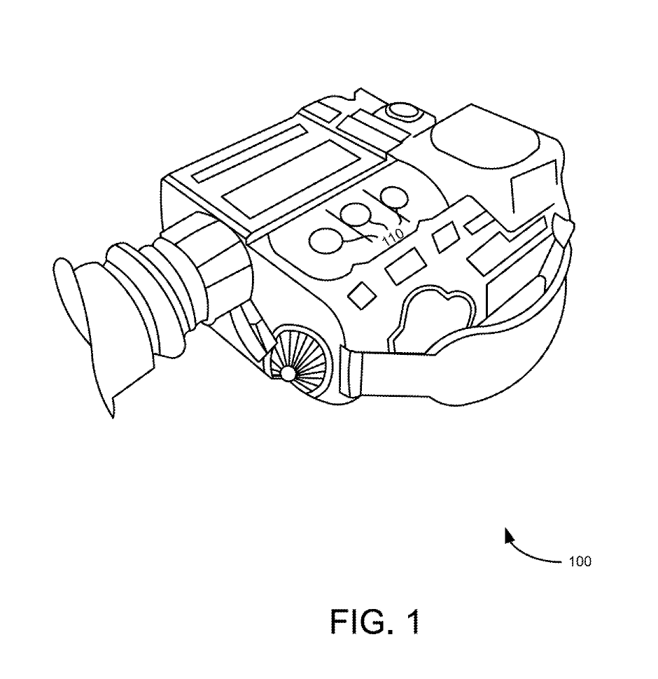

FIG. 1 is a perspective view of a targeting system 100, such as a day/night camera including user friendly controls, according to an example embodiment of the present subject matter. FIG. 1 shows the targeting system 100, such as the day/night camera including the controls, i.e., 3 multi-function buttons 110. In some embodiments, the 3 multi-function buttons 110 are configured to change functions based on modes while maintaining same basic functionality for intuitive use. In these embodiments, fingers of a targeting system user may be used to operate the 3 multi-function buttons 110. For example, a ring finger of the targeting system user may be used for mode specific functions, a middle finger may be used for changing modes of operation (e.g., a day mode, a night mode and so on), and a trigger finger of the targeting system user may be used for firing lasers and so on. Also, in these embodiments, a knob may be used to traverse and make analog type adjustments. In some embodiments, a power toggle switch or a toggle switch having 3 positions (OFF, ON/STANDBY, and START positions) may be used to enable to change functions based on modes while maintaining same basic functionality for intuitive use.

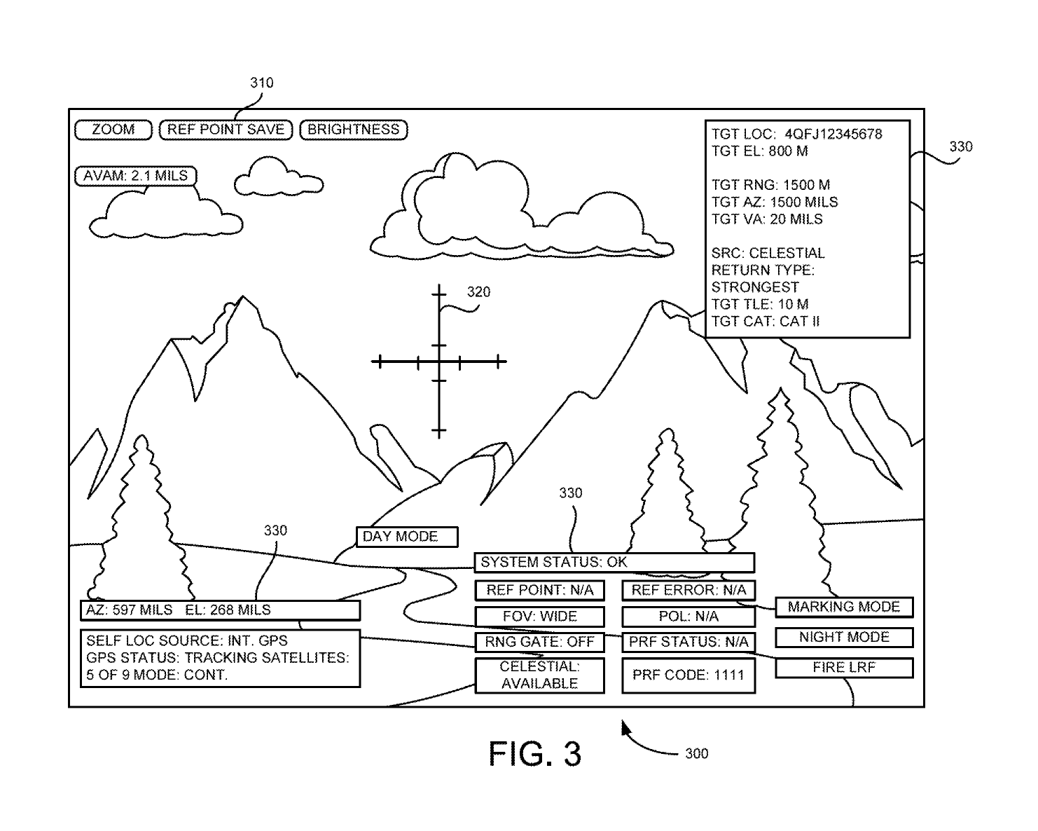

To facilitate rapid actions, such as laser range finder (LRF) fire commands, multi-function buttons 110 as denoted in FIG. 1 may be used. The functions of the multi-function buttons 110 may be reassigned depending on mode/operational state section. In all targeting modes a first multi-function button for a fore finger is LRF firing. In the maintenance mode, the functions of the multi-function buttons 110 may be reassigned depending on the task to be performed in the targeting system. Some example functional aspects of the multi-function button assignment are depicted in FIG. 3 in a lower right corner of a user friendly interface. In one example, the user friendly interface and controls include smart phone and/or mobile device type user friendly interface and control schemes (e.g., methods and so on).

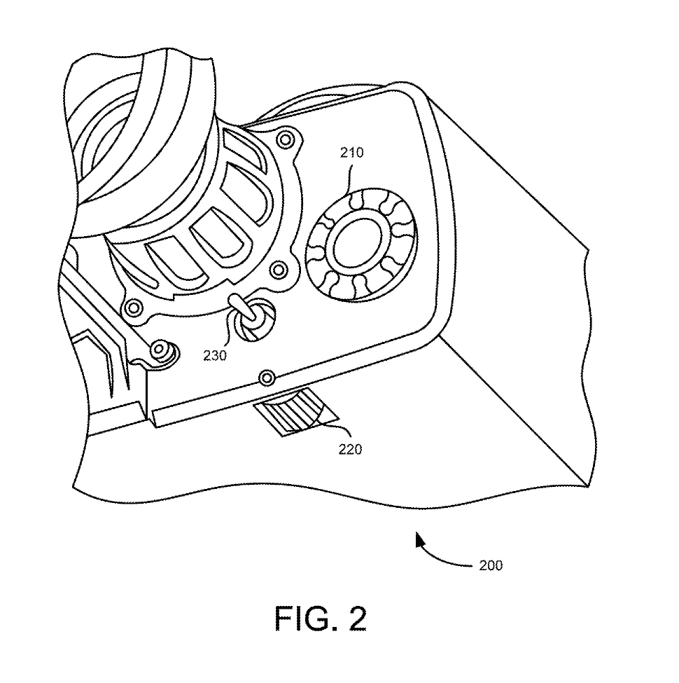

FIG. 2 is a perspective view 200 of a rear side of the day./night camera 100, such as the one shown in FIG. 1, according to an example embodiment of the present subject matter. FIG. 2 shows the rear side of the day/night camera 100 including a rotary control 210, a focus control 220 and an on/off/standby switch 230 that can be used for menu navigation and selection in an user friendly interface by the targeting system user during operation. This is explained in more detailed with reference to FIG. 3. Further in these embodiments, the targeting system user may use the rotary control (with or without push button used for selection) 210 for analog adjustments. Furthermore in these embodiments, the rotary control 210 may direct mechanical drive of a night sensor focus of a night camera and/or a fixed focus of a day camera. In the embodiment shown in FIG. 2, the on/off/standby switch 230 is positioned to allow access while in a carry pouch when mounted on the targeting system user's hip. Further as shown in FIG. 2, the focus control 220 is positioned to allow the user to adjust focus with his thumb.

FIG. 3 is a feature overview 300 showing an example user friendly interface (hereinafter referred as an user interface) seen in a view finder of the day/night camera 100, shown in FIGS. 1 and 2, according to an example embodiment of the present subject matter. It can be seen in FIG. 3, the feature overview 300 seen by the targeting system user is a full screen color display including drop down menus 310, easily legible symbology 320 and/or text/results 330 to streamline and optimize the targeting system user experience. For example, the user interface includes a graphical user interface (GUI) including functions or data available to the targeting system user for prosecuting a target. In some embodiments, the user friendly interface and control schemes, such as shown in FIGS. 1-3 enable an optimized targeting user experience that allows the user to guide precision fires with faster speed and reduced error rates.

In one example, controls, shown in FIGS. 1 and 2 are used for accessing the user interface shown in the feature overview 300 from a single hand position to facilitate targeting system user's eyes to focus on a target during an operation. For example, in operation, a targeting system user may use the 3-multi-function buttons 110 (shown in FIG. 1), and the rotary control (with or without push button) 210 (shown in FIG. 2) for drop down menu 310 navigation using a single hand position to facilitate targeting system user's eyes to focus on a target during an operation and may also use easily legible symbology 320 and/or text results 330 (shown in FIG. 3) to acquire and prosecute targets. Further, the rotary control 210 may be configured to allow the targeting system user to navigate the user interface shown in FIG. 3. Each item denoted by 330 in FIG. 3 can be selected or highlighted by using the rotary control 210 enabled by a targeting user's thumb in a rotary motion. When a correct item 330 in FIG. 3 is highlighted in the user interface using the rotary control 210, then the highlighted item or items can be selected by using the push button disposed in the middle of the rotary control 210 or by pushing the rotary control 210. Once the highlighted item in the user interface is selected, additional information may be presented to the targeting system user until the targeting system user releases with a second push of the rotary control 210.

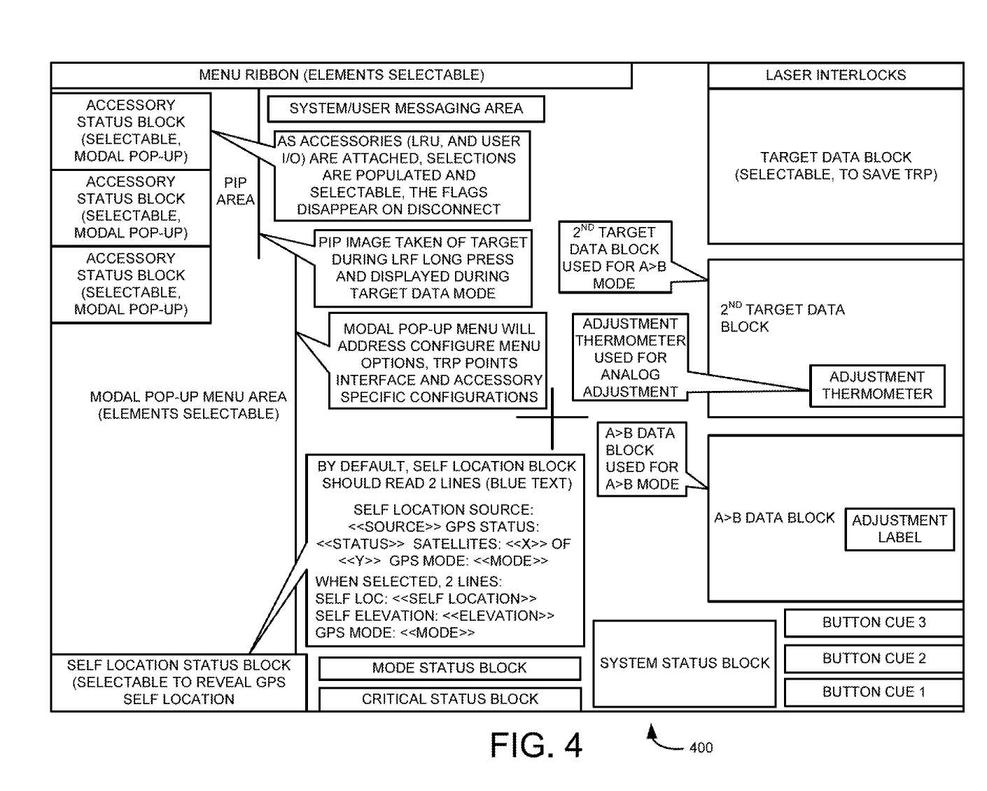

FIG. 4 is an example user friendly interface 400 displaying layers of data and its position on the user friendly interface 400, according to an example embodiment of the present subject matter. Particularly, FIG. 4 represents the layers of data available to the user and its position on the user friendly interface 400. The data is available to the user when selected using the rotary control 210, shown in FIG. 2, and can be removed when no longer needed.

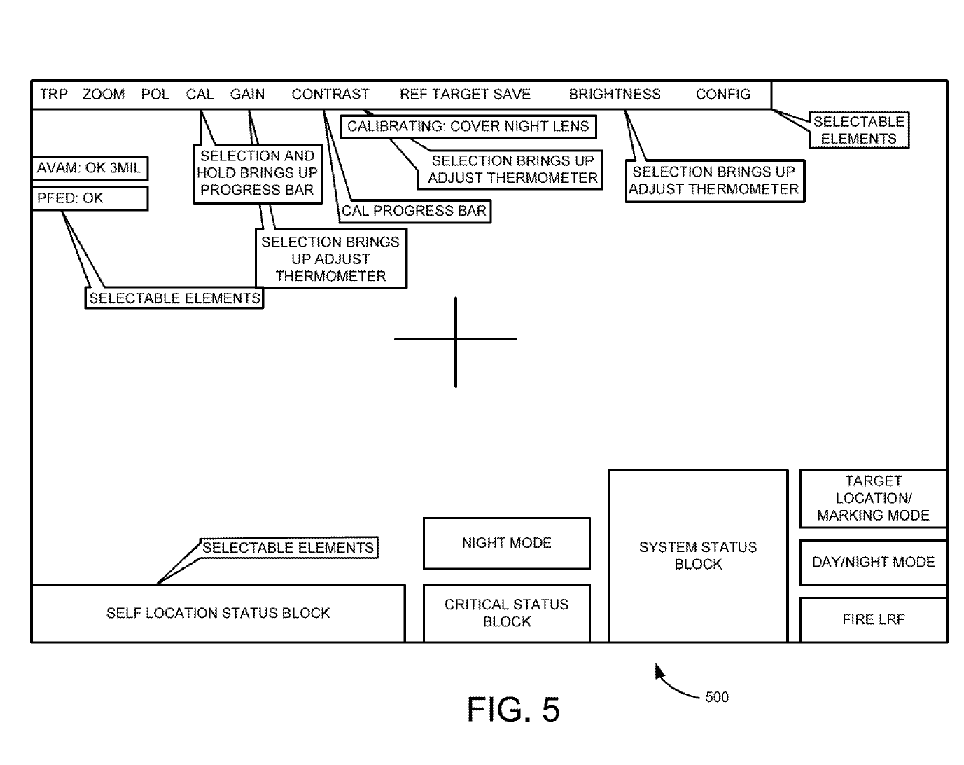

FIG. 5 is an example user friendly interface 500 displaying functions when the day/night camera, shown in FIGS. 1 and 2, is operating in a night mode, according to an example embodiment of the present subject matter. Particularly, FIG. 5 represents the user friendly interface 500 displaying functions need to prosecute a target during night time. These functions are available when selected using rotary/select controls, shown in FIG. 2.

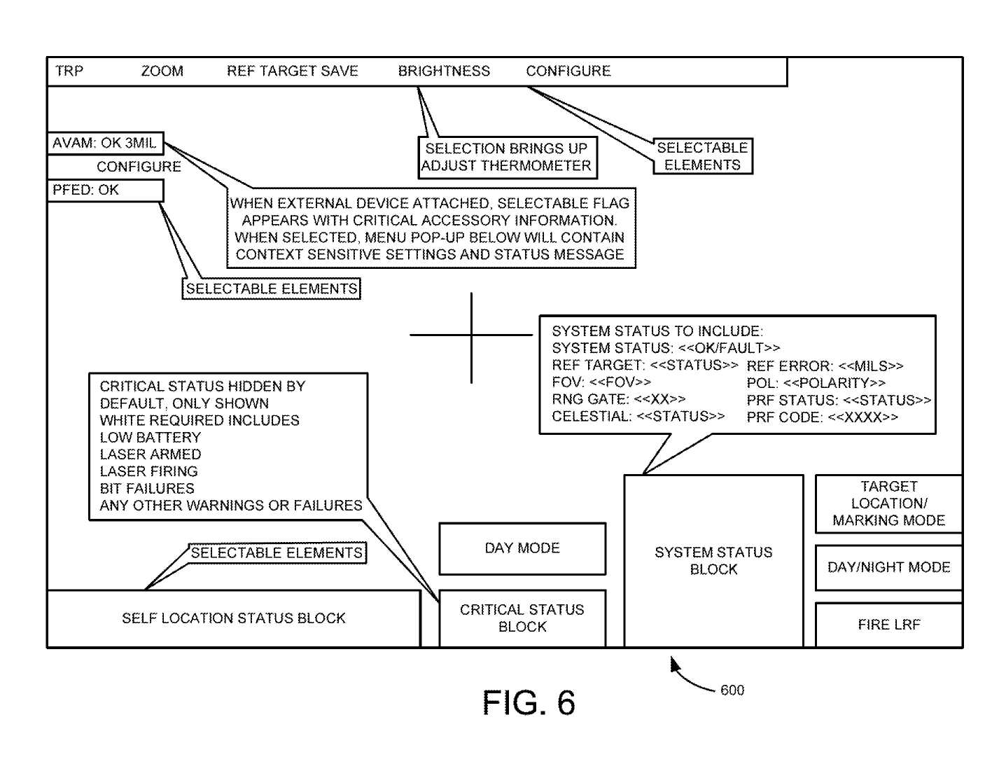

FIG. 6 is an example user friendly interface 600 displaying functions when the day/night camera, shown in FIGS. 1 and 2, is operating in a day mode, according to an example embodiment of the present subject matter. Particularly, FIG. 6 represents the user friendly interface 600 displaying functions need to prosecute a target during day time. These functions are available when selected using rotary/select controls, shown in FIG. 2.

It can be seen that even though the above technique is explained with reference to the day/night camera 100, one skilled in the art can envision that the above technique can be used in any other targeting device and may form a standard by which future targeting devices can be similarly integrated. Example targeting devices are a day camera, a night camera, and/or a day/night camera. Even though the FIGS. 4-6 include functions need to prosecute the target in different modes, one skilled in the art can envision that these functions may also include reference targeting, maintenance, calibration, built in test (BIT), geo-reference, terrestrial mapping/compassing, infra red (IR) marking/designation, and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications. as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A targeting system, comprising:
user friendly interfaces; and
controls for accessing. the user friendly interfaces from a single hand position to facilitate targeting system user's eyes to focus on a target during an operation.

2. The targeting system of claim 1, wherein the user friendly interfaces and controls comprise smart phone and/or mobile device type user friendly interfaces and control schemes.

3. The targeting system of claim 1, wherein the user friendly interfaces comprise graphical user interfaces (GUIs) and/or full screen color displays, and wherein the controls comprise rotary controls, focus controls, multi-function buttons, on/off/standby switches, and/or toggle switches.

4. The targeting system of claim 1, wherein the user friendly interfaces and controls enable the targeting system user's experience faster to acquire and prosecute targets.

5. The targeting system of claim 1, wherein the user friendly interfaces and controls enable an optimized targeting user experience that allows the targeting system user to guide precision fires with faster speed and reduced error rates.

6. The targeting system of claim 1, wherein the targeting system is a day camera, a night camera and/or a day/night camera.

7. A targeting system, comprising:
user friendly interfaces; and
controls for accessing the user friendly interfaces from a single hand position to facilitate targeting system user's eyes to focus on a target during an operation, wherein the user friendly interfaces and controls comprise smart phone and/or mobile device type user friendly interfaces and control schemes, and wherein the user friendly interfaces comprise graphical user interfaces (GUIs) and/or full screen color displays, and wherein the controls comprise rotary controls, focus controls, multi-function buttons, on/off/standby switches, and/or toggle switches.

8. The targeting system of claim 7, wherein the user friendly interfaces and controls enable the targeting system user's experience faster to acquire and prosecute targets.

9. The targeting system of claim 7, wherein the user friendly interfaces and controls enable an optimized targeting user experience that allows the targeting system user to guide precision fires with faster speed and reduced error rates.

10. The targeting system of claim 7, wherein the targeting system is a day camera, a night camera and/or a day/night camera.
